(19) United States
(12) Patent Application Publication
(10) Pub. No.: US 2014/0006752 A1
(43) Pub. Date: Jan. 2, 2014

(54) Qualifying Software Branch-Target Hints with Hardware-Based Predictions

(71) Applicants: Michael William Morrow, Wilkes-Barre, PA (US); James Norris Dieffenderfer, Apex, NC (US); Thomas Andrew Sartorius, Raleigh, NC (US); Michael Scott McIlvaine, Raleigh, NC (US); Brian Michael Stempel, Raleigh, NC (US); Daren Eugene Streett, Cary, NC (US)

(72) Inventors: Michael William Morrow, Wilkes-Barre, PA (US); James Norris Dieffenderfer, Apex, NC (US); Thomas Andrew Sartorius, Raleigh, NC (US); Michael Scott McIlvaine, Raleigh, NC (US); Brian Michael Stempel, Raleigh, NC (US); Daren Eugene Streett, Cary, NC (US)

(73) Assignee: QUALCOMM INCORPORATED, San Diego, CA (US)

(21) Appl. No.: 13/534,649

(22) Filed: Jun. 27, 2012

(51) Int. Cl. G06F 9/40

(52) U.S. Cl. 712/205

(57) ABSTRACT

A processor architecture to qualify software target-branch hints with hardware-based predictions, the processor including a branch target address cache having entries, where an entry includes a tag field to store an instruction address, a target field to store a target address, and a state field to store a state value. Upon decoding an indirect branch instruction, the processor determines whether an entry in the branch target address cache has an instruction address that matches the address of the decoded indirect branch instruction; and if there is a match, depending upon the state value stored in the entry, the processor will use the stored target address as the predicted target address for the decoded indirect branch instruction, or will use a software provided target address hint if available.

### FIELD OF DISCLOSURE

The present invention is related to processor architecture, and more particularly to systems for predicting target addresses for indirect branch instructions.

### BACKGROUND

In a processor instruction set, an indirect branch instruction is an instruction that directs a processor to branch program control to a target address specified by the indirect branch instruction. For example, an indirect branch instruction may specify that a target address is stored in some register, where the next instruction should be fetched at the target address found in that register.

A problem is that the target address may not be known when the indirect branch instruction is decoded because it needs to be computed. The processor could wait for the target address to be computed and stored in the designated register before fetching the next instruction at the target address. However, this will slow down the processor. To avoid this, some processor instruction sets include a hint instruction whereby the assembler inserts a hint instruction specifying a predicted target address. This can speed up processor performance, although there is a penalty if the prediction is found to be wrong because then the processor pipeline will need to be flushed and control will need to go back to the original branch.

Some processor architectures include hardware-based prediction of target addresses. In the case in which both hardware-based and software-based predictions of target addresses are available, the processor architecture must be designed in such a way to use either the software hint or the hardware prediction. The way in which the hardware makes this choice can affect performance and power.

### SUMMARY

Embodiments of the invention are directed to systems and methods for qualifying software branch-target hints with hardware-based predictions.

In an embodiment, a processor includes a branch target address cache storing a table of entries, where each entry has a tag field to store instruction addresses, a target field to store predicted target addresses, and a state field to store state values. Upon decoding an indirect branch instruction, where an entry in the branch target address cache has a tag field value matching the address of the indirect branch instruction, the processor loads into a program counter the value of the target field of the entry depending upon the state value stored in the state field of the entry.

In another embodiment, a method qualifies software target-branch hints with hardware-based predictions. The method includes decoding an indirect branch instruction having an instruction address; computing a target address of the indirect branch instruction; and accessing a branch target address cache to determine if an entry has a stored address value matching the instruction address. The method further includes, provided there is a match, determining a state value stored in the entry, the state value belonging to a set, where the entry has a stored target value; and using the stored target value as the predicted target address for the indirect branch instruction only if the state value belongs to a proper subset of the set.

### BRIEF DESCRIPTION OF THE DRAWINGS

The accompanying drawings are presented to aid in the description of embodiments of the invention and are provided solely for illustration of the embodiments and not limitation thereof

FIG. 1 is an illustration of a processor according to an embodiment.

FIG. 2 depicts a state transition diagram according to an embodiment.

FIG. 3 is a flow diagram illustrating a method according to an embodiment.

FIG. 4 illustrates a cellular phone network in which embodiments may find application.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The term “embodiments of the invention” does not require that all embodiments of the invention include the discussed feature, advantage or mode of operation. The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof

Further, many embodiments are described in terms of sequences of actions to be performed by, for example, elements of a computing device. Specific circuits (e.g., application specific integrated circuits (ASICs)), program instructions being executed by one or more processors, or a combination of both, may perform the various actions described herein. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

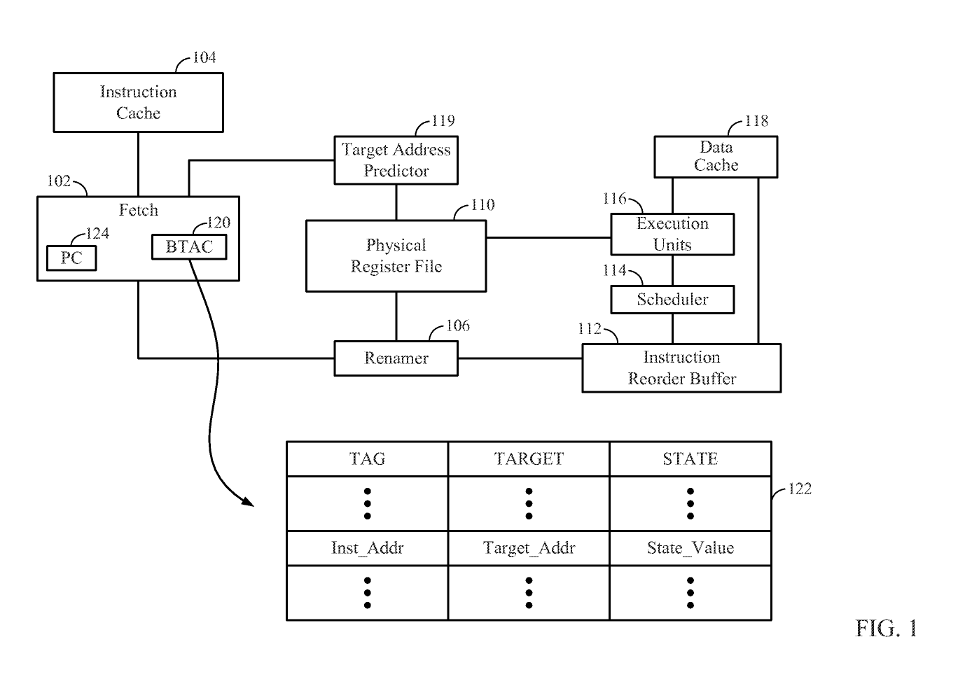

FIG. 1 illustrates at a high level of abstraction a processor system according to an embodiment. Before describing in detail the embodiments, it is pedagogically useful to briefly describe some of the functional units illustrated in FIG. 1. Fetch Functional Unit 102 loads executable instructions from Instruction Cache 104 for execution by the processor system. If an instruction names a logical register as one of its operands, Renamer Functional Unit 106 renames the instruction by mapping the logical register to a physical register in Physical Register File 110. Instruction Reorder Buffer 112 holds instructions and associated information. Instruction Reorder Buffer 112, along with the register renaming function of Renamer Functional Unit 106, helps facilitate out-of-order processing, instruction parallelism, and speculative execution.

Continuing further with a brief description of some of the functional units illustrated in FIG. 1, Scheduler 114 schedules instructions stored in Instruction Reorder Buffer 112 to Execution Units 116. Reservation stations (not shown) implementing Tomasulo's algorithm (or variations thereof) may implement the scheduling function of Scheduler 114. Execution Units 116 may retrieve data from Data Cache 118, and retrieve data from or write data to Physical Register File 110, depending upon the instruction to be executed. As instructions commit and retire from Instruction Reorder Buffer 112, results may also be written to Data Cache 118 or to Physical Register File 110.

Target Address Predictor 119 provides hardware prediction for target addresses of indirect branch instructions. As will be described later, embodiments add additional information to the predicted target addresses so that both software hints and hardware prediction are handled in a unified approach. Accordingly, any of the well-known methods of using hardware for predicting the target addresses associated with indirect branch instructions may be used in the disclosed embodiments.

The above-described functional units in the processor system of FIG. 1 are well known in the art of processor architecture. The above description is not meant to exclude other processor architectures that may be illustrated by different combinations of functional units, but is meant to include a broad spectrum of modern processor architectures.

Furthermore, many functional blocks are left out or simplified for ease of discussion and illustration. For example, if an instruction is not found in Instruction Cache 104, then an instruction cache miss occurs and another level of system memory hierarchy is accessed to load the desired instruction. Similar comments apply to data stored in Data Cache 118, where the processor system handles a data cache miss by accessing another level of memory hierarchy. As another example of the simplification implied in FIG. 1, the registers making up Physical Register File 110 may for some architectures be grouped into two or more types of register files, where for example one type of register file comprises general-purpose registers and a second type of register file comprises floating point registers.

Furthermore, the way in which the capabilities of register renaming, instruction scheduling, and the functionality of Instruction Reorder Buffer 112 are utilized to facilitate out-of-order processing and parallelism are well known in the art of processor architecture, and need not be described in this specification to support the disclosed embodiments.

According to embodiments, a branch target address cache, denoted as BTAC 120 in FIG. 1, is available to Fetch Functional Unit 102 for providing predictions of target addresses of indirect branch instructions. BTAC 120 comprises a table, labeled 122 in FIG. 1 and referred to as a BTAC table. An entry in the BTAC table comprises three fields, denoted in FIG. 1 as “TAG”, “TARGET”, and “STATE”. An entry is shown in table 122 comprising the value Inst_Addr for the TAG field, the value Target_Addr for the TARGET field, and the value State_Value for the STATE field. These three values represent, respectively, the address of an indirect branch instruction, the hardware-based prediction of a target address of the indirect branch instruction, and a state representing a confidence associated with the predicted target address. The values in the TAG field serve as keys to the BTAC table.

When an indirect branch instruction is loaded and decoded by Fetch Functional Unit 102, the BTAC table in BTAC 120 is searched using the address of the decoded indirect branch instruction as a key. If a valid entry is found in the BTAC table having a value in the TAG field matching the indirect branch instruction address, then a hit is declared and depending upon the value stored in the STATE field of that entry, the value stored in the TARGET field for that entry may be placed in program counter register PC 124. If the value in the TARGET field is placed in PC 124, then the next instruction loaded by Fetch Functional Unit 102 is fetched from Instruction Cache 104 (or a higher level in the memory hierarchy) at the predicted target address stored in PC 124.

For some embodiments, in determining whether to use the value provided in the TARGET field of an entry in the BTAC table for which there is a hit, the value of the state in the STATE field of the entry is compared to a threshold. For some embodiments, the value in the TARGET field for that BTAC table entry is taken as the predicted target address and placed into PC 124 only if the value of the state for that entry exceeds the threshold, whereas for some embodiments this is done only if the value of the state is equal to or greater than the threshold.

The above determination involving the comparison of the state value to a threshold may be generalized as follows. The value provided in the TARGET field in the entry for which there is a hit is taken as the predicted target address and placed into PC 124 only if the value of the state in the STATE field of the entry belongs to some set of state values. In practice, this set of state values is a proper subset of the set of all possible state values. An example is given below.

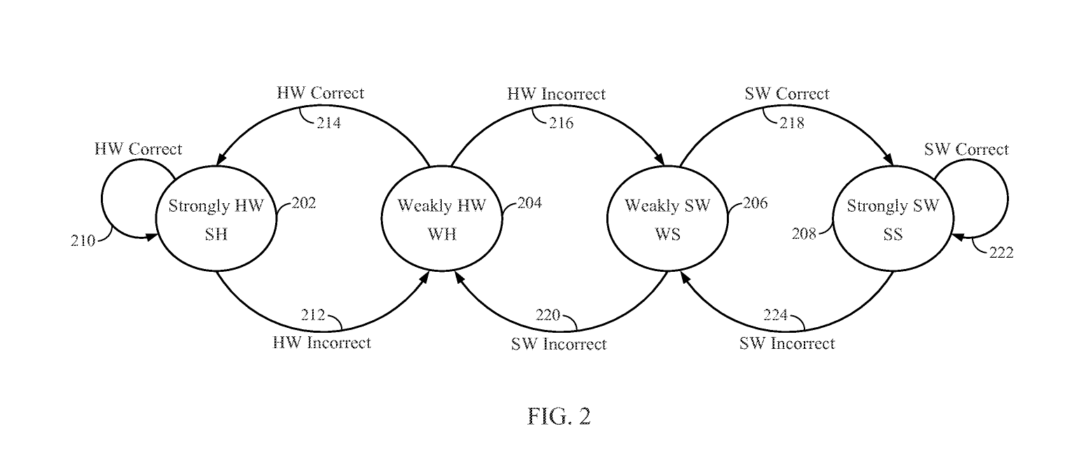

FIG. 2 illustrates an example of an embodiment comprising four states: a state labeled 202 in FIG. 2 and referred to as the Strongly HW prediction state, or more simply as the SH state; a state labeled 204 and referred to as the Weakly HW prediction state, or more simply as the WH state; a state labeled 206 and referred to as the Weakly SW prediction state, or more simply as the WS state; and a state labeled 208 and referred to as the Strongly SW prediction state, or more simply as the SS state. In this example embodiment, the assembler provides software hints.

Suppose for the embodiment illustrated in FIG. 2 that upon decoding an indirect branch instruction there is a hit on an entry in the BTAC table for which the state value indicates the SH state (202). Then the value in the TARGET field of the BTAC table entry is taken as the predicted target address and placed into PC 124. If later it is determined that the predicted target address for the indirect branch instruction is indeed the correct target address, then the state transition for the state in the table entry associated with that indirect branch instruction is the state transition labeled 210 HW Correct in FIG. 2, where “HW Correct” is a mnemonic for the event that the hardware prediction was correct. This state transition keeps the state as the SH state.

On the other hand, if the hardware prediction was wrong, that is, if it is found at a later time that the predicted target address is incorrect, then the state transition labeled 212 HW Incorrect is taken, indicating that the state transitions from the SH state to the WH state (204). Various pipelines will need to be flushed and program control needs to move back to the indirect branch instruction for which the target address was incorrectly predicted. Such techniques for handling a branch misprediction are well known in the art of processor architecture and need not be described in this specification because it is ancillary to the teaching of the disclosed embodiments.

Suppose for the embodiment illustrated in FIG. 2 that upon decoding an indirect branch instruction there is a hit on an entry in the BTAC table for which the state is the WH state (204). Then the value in the TARGET field of the BTAC table entry is taken as the predicted target address and placed into PC 124. If later it is determined that the predicted target address for the indirect branch instruction is the correct target address, then the state transition for the state in the table entry for that indirect branch instruction is the state transition labeled 214 HW Correct in FIG. 2. This state transition moves the state to the SH state.

On the other hand, if the hardware prediction was wrong, then the state transition labeled 216 HW Incorrect is taken, indicating that the state transitions from the WH state to the WS state (206).

Now suppose there is a hit on an entry in the BTAC table for which the state is the WS state (206). Then the value in the TARGET field of the BTAC table entry is ignored, and the target address suggested by the relevant software hint for the indirect branch instruction is taken as the predicted target address and placed into PC 124. If later it is determined that the predicted target address suggested by the software hint for the indirect branch instruction is indeed the correct target address, then the state transition for the state in the table entry for that indirect branch instruction is the state transition labeled 218 SW Correct in FIG. 2. This state transition moves the state to the SS state (208).

On the other hand, if the software prediction was wrong, then the state transition labeled 220 SW Incorrect is taken, indicating that the state transitions from the WS state to the WH state.

Finally, suppose there is a hit on an entry in the BTAC table for which the state is the SS state (208). Then the value in the TARGET field of the BTAC table entry is ignored, and the target address suggested by the relevant software hint for the indirect branch instruction is taken as the predicted target address and placed into PC 124. If later it is determined that the predicted target address suggested by the software hint for the indirect branch instruction is indeed the correct target address, then the state transition for the state in the table entry for that indirect branch instruction is the state transition labeled 222 SW Correct in FIG. 2. The state stays in the SS state.

On the other hand, if the software prediction was wrong, then the state transition labeled 224 SW Incorrect is taken, indicating that the state transitions from the SS state to the WS state.

In the example of FIG. 2, {SH, WH, WS, SS} is the set of all possible states, and {SH, WH} is the proper subset of the set of all possible states for which the processor system accepts the hardware prediction. That is, the processor system chooses for the predicted target address the value in the TARGET field of the entry in the BTAC table for which there is a hit only if the state for that entry belongs to the subset {SH, WH}.

Alternatively, the state may be encoded by the following two-bit code: State_Value=00₂ for the SS state; State_Value=01₂ for the WS state; State_Value=10₂ for the WH state; and State_Value=11₂ for the SH state. The hardware prediction is taken only if the state value is such that State_Value≧10₂. In this case, the threshold as previously discussed is 10₂.

The above example embodiment is easily generalized to systems employing more than four states.

If the assembler is actively providing software hints, but there is no hit in the BTAC table, then the processor system proceeds with software prediction. If the assembler is not providing software hints, then the processor system may use any well-known technique for hardware prediction, as well as no prediction if a hardware-based predicted target address is not available.

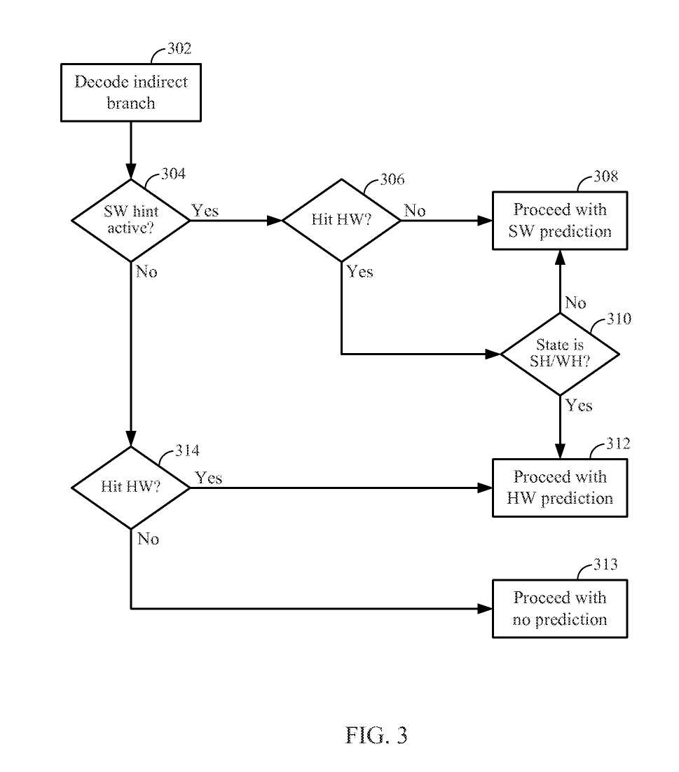

FIG. 3 illustrates a method according to an embodiment. Upon decoding an indirect branch instruction (302), and provided the assembler is providing software hints (the “Y” branch for 304), a determination is made as to whether there is a hit in the BTAC table (306). If there is no hit (the “N” branch of 306), then the processor system proceeds with the software hint provided by the assembler (308). If, however, there is a hit in the BTAC table (the “Y” branch of 306), then a determination is made as to the state value associated with the entry found in the BTAC table (310). If the state is SH or WH (the “Y” branch of 310), then hardware prediction proceeds (312), that is, the value in the TARGET field of the entry for which there is a hit is the predicted target address that is placed into PC 124. But if the state is neither SH nor WH (the “N” branch of 310), then the processor system proceeds with target address prediction based upon the software hint (308).

If software hinting is not active (the “N” branch of 304), then standard hardware prediction techniques follow. A determination is made as to whether there is a hit in the BTAC table (314). If there is a hit (the “Y” branch of 314), then the processor system proceeds with hardware prediction (312). If there is not a hit (the “N” branch of 314), then the processor system does not proceed with target address prediction (313).

An example of assembly language code for an ARM® processor containing a software-based branch instruction hint and an indirect branch instruction is provided in Table 1 below, where comments on the instructions follow the semi-colon. (ARM is a trademark of ARM Ltd.) In the example of Table 1, the assembler has provided the instruction hint PLI indicating that the predicted target address for the indirect branch instruction BLX is the value stored in register R1. Note that the first instruction computes the value stored in register R1. However, the target address for the BLX instruction is easily predicted, for it always is the invariant value stored in register R1, so that in this example the hardware prediction should override the software prediction. This would be the case for the embodiments described above, so that it is expected that embodiments for examples of the type illustrated in Table 1 are more time and power efficient than prior art systems relying only upon software hints.

TABLE 1
LOOP

| | | |
|---|---|---|
| ADD | R1, R8, #4 | ; compute branch target |
| PLI | [R1] | ; SW branch hint |
| SUBS | R9, #1 | ; loop count |
| LDR | R0, [R5], #4 | ; load |
| BLX | R1 | ; indirect branch (call) |
| BNE | LOOP | ; conditional branch to beginning of loop |

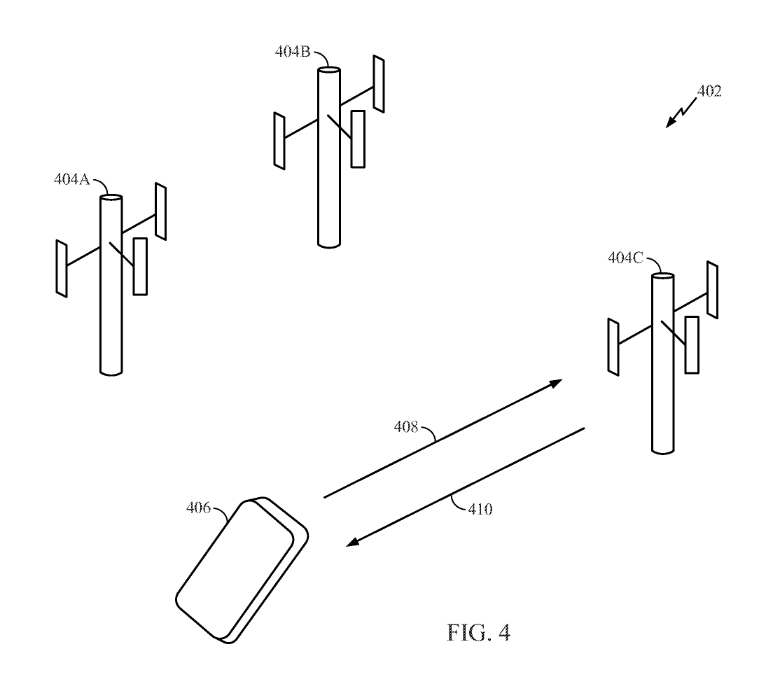

Embodiments may find widespread application in numerous systems, such as a cellular phone network. For example, FIG. 4 illustrates a cellular phone network 402 comprising Base Stations 404A, 404B, and 404C. FIG. 4 shows a communication device, labeled 406, which may be a mobile cellular communication device such as a so-called smart phone, a tablet, or some other kind of communication device suitable for a cellular phone network. Communication Device 406 need not be mobile. In the particular example of FIG. 4, Communication Device 406 is located within the cell associated with Base Station 404C. Arrows 408 and 410 pictorially represent the uplink channel and the downlink channel, respectively, by which Communication Device 406 communicates with Base Station 404C.

Embodiments may be used in data processing systems associated with Communication Device 406, or with Base Station 404C, or both, for example. FIG. 4 illustrates only one application among many in which the embodiments described herein may be employed.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for qualifying software branch-target hints with hardware-based predictions. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A processor comprising:
a fetch functional unit to load and decode instructions, wherein the instructions include an indirect branch instruction and a target address hint for the indirect branch instruction, the indirect branch instruction having an address;
a program counter to store instruction addresses;
a branch target address cache to store a table of entries, each entry comprising a tag field to store instruction addresses, a target field to store predicted target addresses, and a state field to store state values;
wherein upon decoding the indirect branch instruction, for an entry in the branch target address cache having a tag field value matching the address of the indirect branch instruction, the processor loads into the program counter the value of the target field of the entry depending upon the state value stored in the state field of the entry.

2. The processor as claimed in claim 1, the state values belonging to a set, wherein the processor loads into the program counter the value of the target field of the entry only if the state value stored in the state field of the entry belongs to a proper subset of the set.

3. The processor as claimed in claim 2, the set comprising a first value, a second value, a third value, and a fourth value, the proper subset consisting of the first value and the second value.

4. The processor as claimed in claim 3, the processor to compute the target address of the indirect branch instruction, and provided the state value equals the first value upon decoding the indirect branch instruction, the processor to
change the state value from the first value to the second value only if the value of the target field loaded into the program counter is determined by the processor not to match the computed target address of the indirect branch instruction;
maintain the state value as the first value only if the value of the target field loaded into the program counter is determined by the processor to match the computed target address of the indirect branch instruction.

5. The processor as claimed in claim 4, provided the state value equals the second value upon decoding the indirect branch instruction, the processor to
change the state value from the second value to the third value only if the value of the target field loaded into the program counter is determined by the processor not to match the computed target address of the indirect branch instruction;
change the state value from the second value to the first value only if the value of the target field loaded into the program counter is determined by the processor to match the computed target address of the indirect branch instruction.

6. The processor as claimed in claim 5, the target address hint providing a software-based address, provided the state value equals the third value upon decoding the indirect branch instruction, the processor to load the software-based address into the program counter, and the processor to
change the state value from the third value to the fourth value only if the software-based address loaded into the program counter is determined by the processor to match the computed target address of the indirect branch instruction;
change the state value from the third value to the second value only if the software-based address loaded into the program counter is determined by the processor to not match the computed target address of the indirect branch instruction.

7. The processor as claimed in claim 6, provided the state value equals the fourth value upon decoding the indirect branch instruction, the processor to load the software-based address into the program counter, and the processor to
maintain the state value as the fourth value only if the software-based address loaded into the program counter is determined by the processor to match the computed target address of the indirect branch instruction;
change the state value from the fourth value to the third value only if the software-based address loaded into the program counter is determined by the processor to not match the computed target address of the indirect branch instruction.

8. The processor set forth in claim 1, wherein the processor loads into the program counter the value of the target field of the entry only if the state value stored in the state field of the entry is greater than a threshold.

9. The processor set forth in claim 1, wherein the processor loads into the program counter the value of the target field of the entry only if the state value stored in the state field of the entry is equal to or greater than a threshold.

10. A method to qualify software target-branch hints with hardware-based predictions, the method comprising:
decoding an indirect branch instruction having an instruction address;
computing a target address of the indirect branch instruction;
accessing a branch target address cache to determine if an entry has a stored address value matching the instruction address;
provided there is a match, determining a state value stored in the entry, the state value belonging to a set, the entry having a stored target value;
using the stored target value as the predicted target address for the indirect branch instruction only if the state value belongs to a proper subset of the set.

11. The method as claimed in claim 10, further comprising:
decoding a hint instruction providing a target address hint;
using the target address hint as the predicted target address for the indirect branch instruction only if the state value does not belong to the proper subset of the set.

12. The method as claimed in claim 11, wherein the set comprises a first state value, a second state value, a third state value, and a fourth state value.

13. The method as claimed in claim 12, the proper subset consisting of the first state value and the second state value, and provided the state value equals the first value upon decoding the indirect branch instruction, the method further comprising:
changing the state value from the first value to the second value only if the stored target value is determined not to equal the computed target address of the indirect branch instruction;
maintaining the state value as the first value only if the stored target value is determined to equal the computed target address of the indirect branch instruction.

14. The method as claimed in claim 13, provided the state value equals the second value upon decoding the indirect branch instruction, the method further comprising:
changing the state value from the second value to the third value only if the stored target value is determined not to equal the computed target address of the indirect branch instruction;
changing the state value from the second value to the first value only if the stored target value is determined to equal the computed target address of the indirect branch instruction.

15. The method as claimed in claim 14, provided the state value equals the third value upon decoding the indirect branch instruction, the method further comprising:
changing the state value from the third value to the fourth value only if the target address hint is determined to equal the target address of the indirect branch instruction;
changing the state value from the third value to the second value only if the target address hint is determined not to equal the computed target address of the indirect branch instruction.

16. The method as claimed in claim 15, provided the state value equals the fourth value upon decoding the indirect branch instruction, the method further comprising:
maintaining the state value as the fourth value only if the target address hint is determined to equal the computed target address of the indirect branch instruction;
changing the state value from the fourth value to the third value only if the target address hint is determined to not equal the computed target address of the indirect branch instruction.

17. A processor to qualify software target-branch hints with hardware-based predictions, the processor comprising:
means for decoding an indirect branch instruction having an instruction address;
means for accessing a branch target address cache to determine if an entry has a stored address value matching the instruction address;
provided there is a match, means for determining a state value stored in the entry, the state value belonging to a set, the entry having a stored target value;
means for using the stored target value as the predicted target address for the indirect branch instruction only if the state value belongs to a proper subset of the set.

18. The processor as claimed in claim 17, further comprising:
means for decoding a hint instruction providing a target address hint;
means for using the target address hint as the predicted target address for the indirect branch instruction only if the state value does not belong to the proper subset of the set.

19. The processor as claimed in claim 18, wherein the set comprises a first state value, a second state value, a third state value, and a fourth state value.

20. The method as claimed in claim 19, the proper subset consisting of the first state value and the second state value.
